(19) United States
(12) Patent Application Publication
(10) Pub. No.: US 2009/0310761 A1
(43) Pub. Date: Dec. 17, 2009

(54) System and Method for Identifying a Caller by a Customer Premises Equipment Voicemail System and Playing a Previously Recorded Personalized Message to that Caller

(75) Inventor: Amar Nath Ray, Shawnee, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/140,618

(22) Filed: Jun. 17, 2008

(51) Int. Cl. H04M 1/64

(52) U.S. Cl. 379/88.19

(57) ABSTRACT

Embodiments of a system and method for providing a personalized greeting to a caller include receiving an incoming call by a first communication device from caller using a second communication device. The first communication device is located at a customer premise location. The method further includes entering an off-hook mode by the first communication device and determining a caller identity associated with the second communication device. The method still further includes determining if the caller identity matches a pre-assigned caller identifier from a pre-assigned caller list, and playing an outgoing message associated with the pre-assigned caller identifier if the caller identity matches the pre-assigned caller identifier from the pre-assigned caller list.

### BACKGROUND

Customer premise equipment (CPE) that includes a voicemail system provides voicemail services to users at customer premise locations. These voicemail systems allow a caller to leave a voicemail for a user if the user is not available to answer a call from the caller. If the user does not answer an incoming call from a caller, the voicemail system at the customer premise location provides a pre-recorded greeting to the caller, and prompts the caller to leave an incoming message for the user. In existing CPE voicemail systems, the same pre-recorded greeting is played to every caller regardless of their identity.

### BRIEF SUMMARY

To enhance conventional voicemail systems, the principles of embodiments of the present invention provide for a CPE voicemail to be configured by a user to play a specific greeting for a specific caller. By providing a personalized greeting, a user may provide a caller, such as a customer, with a feeling of more personalized service. An embodiment of the invention may provide for a procedure for identifying a specific caller by a customer premise equipment voicemail system to determine a caller identity of the caller. The caller identity may then be matched to a caller identifier associated with the specific caller. A pre-recorded personalized message associated with the caller identifier may be played to the specific caller. Embodiments further provide for a user of the customer premise equipment to record the pre-recorded personalized message and provide the caller identifier associated with the specific caller to determine that the specific caller is calling. In various embodiments, the customer premise equipment voicemail system includes a digital telephone answering device (DTAD). Embodiments further provide for an option for the caller to record an incoming message to the user of the customer premise equipment using the voicemail system after the playing of the pre-recorded personalized message to the caller.

Playing a personalized message for a specific caller facilitates communication between two parties, especially in situations in which the called party is not available and both parties are trying to communicate personalized information. An example situation is one in which someone is expecting a phone call from a caller and can not stay by the phone. In such a situation, he or she can record a personalized message with specific information for the caller, and assign a phone number associated with the caller to the personalized message. When the caller calls at a later time, the personalized message is played back to the caller.

An embodiment of a method for providing a personalized greeting to a caller includes receiving an incoming call by a first communication device from caller using a second communication device. The first communication device is located at a customer premise location. The method further includes entering an off-hook mode by the first communication device and determining a caller identity associated with the second communication device. The method still further includes determining if the caller identity matches a pre-assigned caller identifier from a pre-assigned caller list, and playing an outgoing message associated with the pre-assigned caller identifier if the caller identity matches the pre-assigned caller identifier from the pre-assigned caller list.

An embodiment of an apparatus for providing a personalized greeting to a caller includes at least one processor. The at least one processor is configured to receive an incoming call by a first communication device from caller using a second communication device. The first communication device is located at a customer premise location. The at least one processor is further configured to enter an off-hook mode by the first communication device, and determine a caller identity associated with the second communication device. The at least one processor is further configured to determine if the caller identity matches a pre-assigned caller identifier from a pre-assigned caller list, and play an outgoing message associated with the pre-assigned caller identifier if the caller identity matches the pre-assigned caller identifier from the pre-assigned caller list.

### BRIEF DESCRIPTION OF THE DRAWINGS

Illustrative embodiments of the present invention are described in detail below with reference to the attached drawing figures, which are incorporated by reference herein and wherein:

FIG. 1 illustrates an embodiment of a system for identifying an incoming caller and playing back a previously recorded personalized outgoing message to the incoming caller;

FIG. 2 illustrates an embodiment of a procedure for recording and assigning a personalized outgoing message to an incoming caller;

FIG. 3 illustrates an embodiment of a procedure for identifying an incoming caller and playing back a previously recorded personalized outgoing message to the incoming caller; and

FIG. 4 illustrates an embodiment of a procedure for identifying an incoming caller and playing back a previously recorded personalized outgoing message through a second line.

### DETAILED DESCRIPTION

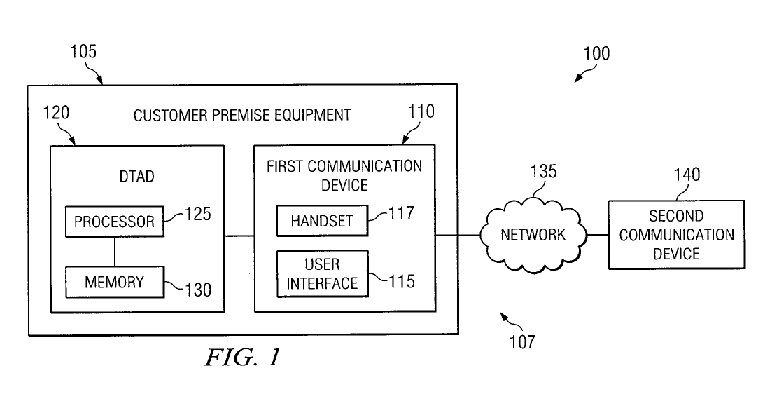

FIG. 1 illustrates an embodiment of a system 100 for identifying an incoming caller and playing back a previously recorded personalized outgoing message to the incoming caller. The system 100 includes customer premise equipment (CPE) 105 located at a customer premise location 107 associated with a user. In at least one embodiment, the CPE 105 is located at a user's home. In another embodiment, the CPE 105 is located at the user's office. The CPE 105 includes a first communication device 110 configured to allow the user to initiate, receive, and participate in communication sessions, such as telephone calls, with other communication devices in communication with one or more communication networks. In at least one embodiment, the first communication device 110 is a telephone. The first communication device 110 includes a user interface 115. In at least one embodiment, the user interface 115 is a keypad. In at least one embodiment, the first communication device 110 further includes a handset 117 including a microphone and a speaker and/or earpiece.

The CPE 105 may further include a digital telephone answering device (DTAD) 120 in communication with the first communication device 110. The DTAD 120 includes a processor 125 and memory 130. The memory 130 is configured to store computer instructions operable to cause a processor 125 to perform the various functions of the DTAD 120 described herein. In at least one embodiment, the memory 130 is configured to store at least one personalized outgoing message recorded by the user of the first communication device 110. In some embodiments, the memory 130 is further configured to store incoming messages from callers. In at least one embodiment, the first communication device 110 and the DTAD 120 are integrated into a single device at a customer premises location 107 to include the CPE 105. In another embodiment, the first communication device 110 and the DTAD 120 are configured as separate devices that are connected together at the customer premises location 107.

The CPE 105 is further in communication with a network 135. In at least one embodiment, the network 135 is a telephone network. The network 135 is in further communication with a second communication device 140. The second communication device 140 may be configured to allow a caller to initiate and participate in communication sessions, such as telephone calls with the first communication device 110. In at least one embodiment, the second communication device 140 is a telephone.

In an example operation of the system 100, the user of the CPE 105 records a personalized outgoing message in the memory 130 of the DTAD 120 via the first communication device 110. The DTAD 120 then associates the personalized outgoing pre-recorded message with a pre-assigned caller identifier associated with the second communication device 140 in response to user input via the user interface 115. In one embodiment, the pre-assigned caller identifier is a phone number associated with the second communication device 140. In another embodiment, the pre-assigned caller identifier is a caller name associated with the second communication device 140. In still other embodiments, more than one caller identifier can be associated with the second communication device 140. For example, both a phone number and a caller name may be associated with the second communication device 140.

When a caller using the second communication device 140 initiates a call to the first communication device 110 and the user of the first communication device 110 is unavailable, the DTAD 120 determines a caller identify of the caller, matches the caller identity to the pre-assigned caller identifier, and plays the personalized outgoing pre-recorded message associated with the pre-assigned caller identifier to the caller of the second communication device 140. In some embodiments, the memory 130 of the DTAD 120 stores a number of pre-assigned caller identifiers and personalized outgoing pre-recorded messages, one or more of which is associated with a different caller or calling device in a pre-assigned caller list. In various embodiments, the DTAD 120 will further prompt the caller of the second communication device 140 to leave an incoming message for the user of the first communication device 110. The incoming message is then stored within the memory 130. The user of the first communication device 110 may then retrieve and listen to the incoming message from the caller of the second communication device 140 at a later time using the first communication device 110.

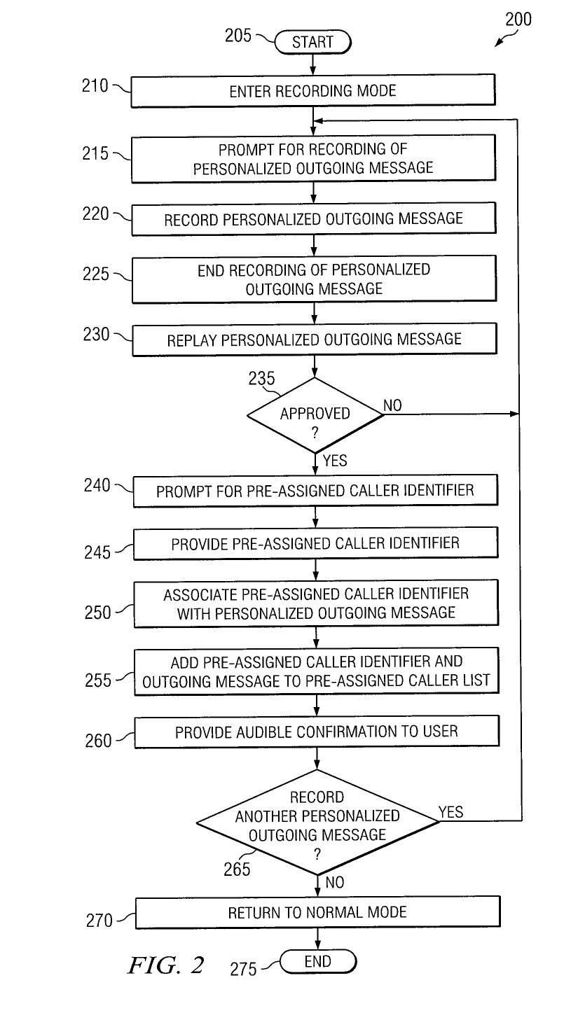

FIG. 2 illustrates an embodiment of a procedure 200 for recording and assigning a personalized outgoing message to an incoming caller. The procedure 200 begins at step 205. In step 210, the CPE 105 (FIG. 1) enters a recording mode. In at least one embodiment, the recording mode is initiated by a user of the first communication device 110. In a particular embodiment, the user may press a key on the user interface 115 of the first communication device 110 to initiate the recording mode. In a particular embodiment, the key is a dual tone multiple frequency (DTMF) key. For example, the user may press the # key or the * key to enable the DTAD 120 to enter the recording mode. In at least one embodiment, the first communication device 110 enters an on-hook mode when in the recording mode. In the on-hook mode, an operating status of a communication line coupling the first communication device 110 to the network 135 is in a state in which data transmission between first communication device 110 and network 135 is disabled. In step 215, the user of the first communication device 110 is prompted by the DTAD 120 to record a personalized outgoing message directed to a particular caller, such as a caller associated with second communication devices 140. In step 220, the user records the personalized outgoing message using the handset 117 of first communication device 110, and the DTAD 120 stores the personalized outgoing message in the memory 130. In step 225, the recording of the personalized outgoing message is ended. In a particular embodiment, the ending of the recording of the personalized outgoing message is indicated by the user pressing a DTMF key, such as the # or * key, on the user interface 115 of the first communication device 110. In step 230, the personalized outgoing message is replayed to the user via the CPE 105. In step 235, the user is prompted for approval of the personalized outgoing message. If the user does not approve the personalized outgoing message, the procedure 200 returns to step 215. If the user approves the personalized outgoing message, the procedure 200 continues to step 240. In at least one embodiment, the user approves the personalized outgoing message by pressing the “1” key on the user interface 115, and disapproves the personalized outgoing message by pressing the “0” key on the user interface 115.

In step 240, the user is prompted for a pre-assigned caller identifier to which the personalized outgoing message recorded by the user is to be associated. In step 245, the user provides the pre-assigned caller identifier to the DTAD 120 using the first communication device 110. In at least one embodiment, the user provides the pre-assigned caller identifier by typing the pre-assigned caller identifier associated with the second communication device 140 using the user interface 115. In other embodiments, the user provides the pre-assigned caller identifier by selecting the pre-assigned caller identifier from a directory that has been previously saved in the DTAD 120 or CPE 105. In one embodiment, the pre-assigned caller identifier is a phone number, which may be identified by receiving a Caller ID number, associated with the second communication device 140. In another embodiment, the pre-assigned caller identifier is a caller name, which may be identified by receiving a Caller ID name, associated with the second communication device 140. In still other embodiments, the user may provide the pre-assigned caller identifier by speaking a name or other identifying phrase associated with a caller or the second communication device 140 into the handset 117 of the first communication device 110.

In step 250, the pre-assigned caller identifier is associated with the personalized outgoing message by the DTAD 120. In step 255, the pre-assigned caller identifier and personalized outgoing message is added to a pre-assigned caller list stored in the memory 130 of the DTAD 120. The pre-assigned caller list includes one or more personalized output message and associated pre-assigned caller identifiers for one or more callers. In step 260, an audible confirmation that the pre-assigned caller identifier and personalized outgoing message has been added to the pre-assigned caller list is provided to the user via the handset 117 of the first communication device 110. In at least one embodiment, the audible confirmation is a beep. In still other embodiments, the audible confirmation is a voice confirmation. In step 265, the user is prompted by the DTAD 120 via the first communication device 110 regarding whether he wishes to record another personalized outgoing message and associate it with another caller. If the user wishes to record another personalized outgoing message, the procedure 200 returns to step 215. If the user does not wish to record another personalized outgoing message, the procedure continues to step 270.

At step 270, the first communication device 110 returns to the normal mode. In the normal mode, a user of the first communication device 110 may place telephone calls and perform other functions associated with the first communication device 110. In step 275, the procedure 200 ends. In at least one embodiment, the recording and association operations of procedure 200 are performed in the on-hook mode to comply with existing rules as specified by the Federal Communications Commission (FCC). In the on-hook mode, a communication line coupling the first communication device 110 to the network 135 is in an idle state. In the idle state, data communication between the first communication device 110 and the network 135 is disabled.

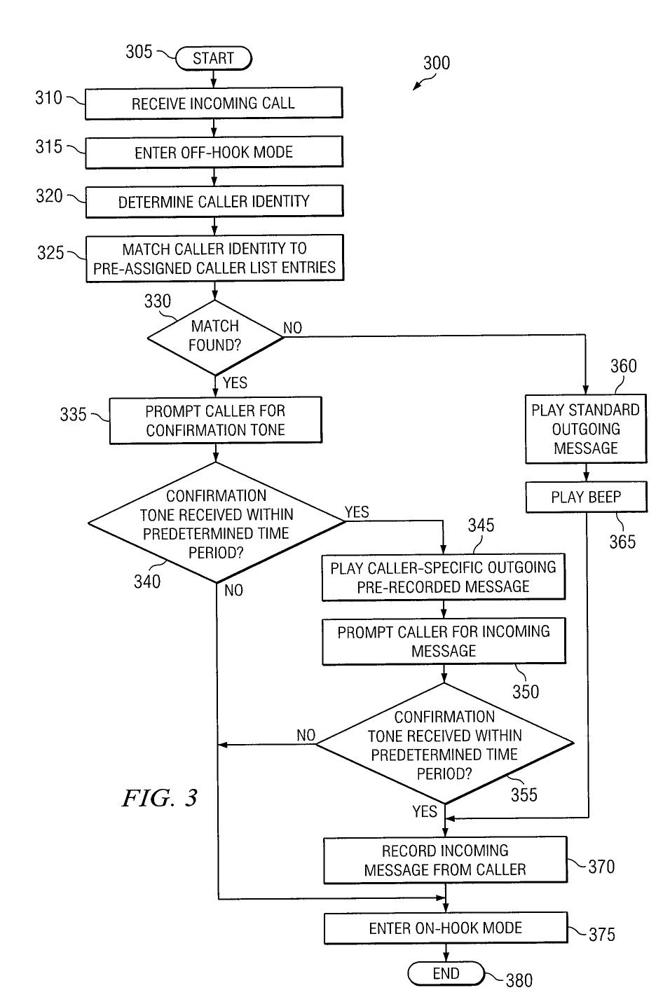

FIG. 3 illustrates an embodiment of a procedure 300 for identifying an incoming caller and playing back a previously recorded personalized outgoing message to the incoming caller. The procedure 300 begins at step 305. At step 310, the CPE 105 receives an incoming call from the second communication device 140. In step 315, the first communication device 110 enters an off-hook mode. In the off-hook mode, a communication line connecting the first communication device 110 to the network 135 that is receiving the incoming call is in an active state in which data transmission is enabled either for voice communications, data communications, and/or network signaling. In at least one embodiment, the DTAD 120 is configured to cause the first communication device 110 to enter the off-hook mode.

In step 320, a caller identity associated with the second communication device 140 is determined. In at least one embodiment, the caller identity is determined from Caller ID information associated with the second communication device 140 received from the second communication device 140 during establishment of the incoming call. In a particular embodiment, the Caller ID information includes Caller ID Type I information. Type I Caller ID provides calling party information while the call is ringing. In step 325, the DTAD 120 determines whether the caller identity matches one of the entries in the pre-assigned caller list. In step 330, if the DTAD 120 matches the caller identity to an entry in the pre-assigned caller list, the procedure 300 continues to step 335. In step 335, an outgoing message is sent to the caller indicating that a personalized outgoing message is available for the caller, and the caller is prompted to provide a confirmation tone to indicate that the caller wishes to listen to the personalized outgoing message. In one example embodiment, the caller is prompted to send a confirmation tone by pressing the “1” key to listen to the personalized outgoing message. In step 340, if it is determined that the caller sent a confirmation tone within a predetermine time period, the procedure 300 continues to step 345. In at least one embodiment, the predetermined time period is determined to comply with rules specified by the Federal Communications Commission (FCC). In a particular embodiment, the predetermined time period is six seconds. In still another embodiment, the predetermined time period is four seconds. In step 345, the caller-specific personalized outgoing message is played by the DTAD 120 to the caller.

In step 350, the caller is prompted regarding whether he wishes to leave an incoming message for the user of the first communication device 110 by entering a confirmation tone. In at least one embodiment, the confirmation tone is a DTMF tone generated by the caller of the second communication device 140 pressing a key on a keypad associated with the second communication device 140. In one example embodiment, the caller is prompted to press the “1” key if he wishes to leave an incoming message to the user of the first communication device 110. In step 355, if a confirmation tone is received from the caller within a predetermined time period, the procedure continues to step 370. In at least one embodiment, the predetermined time period is determined to comply with rules specified by the Federal Communications Commission (FCC). In a particular embodiment, the predetermined time period is six seconds. In still another embodiment, the predetermined time period is four seconds. In step 370, the caller records an incoming message, and the incoming message is stored in the memory 130 of the DTAD 120 and the procedure continues to step 375. In step 375, the first communication device 110 enters an on-hook mode. In the on-hook mode, the operating status of the communication line between the first communication device 110 and the network 135 is in a state in which data transmission is disabled. In at least one embodiment, the DTAD 120 is configured to cause the first communication device 110 to enter the on-hook mode. In step 380, the procedure 300 ends. If in step 340 the confirmation tone is not received within the predetermined time period the procedure continues to step 375. If in step 355 the confirmation tone is not received within the predetermined time period, the procedure 300 continues to step 375.

If in step 330 the DTAD 120 does not match the caller identity to an entry in the pre-assigned caller list, the procedure 300 continues to step 360 in which the DTAD 120 plays a standard outgoing message to the caller. The standard outgoing message is not personalized towards a specific caller. In step 365, the DTAD 120 plays a beep or audible indication to the caller to indicate to the caller to record an incoming message and the procedure continues to step 370, 375, and 380.

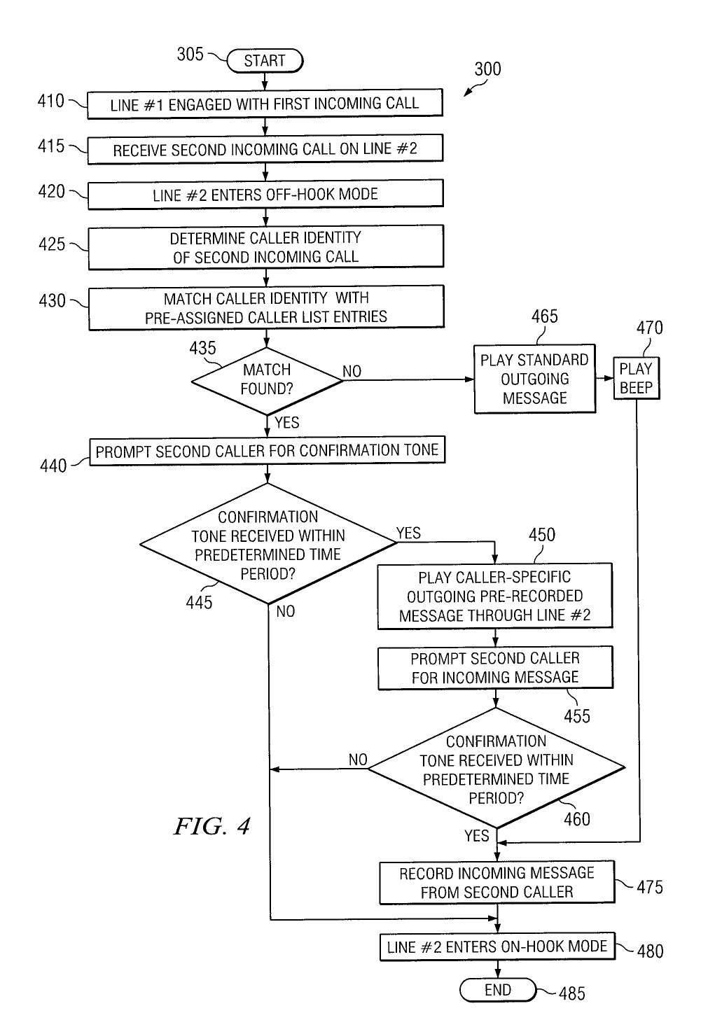

FIG. 4 illustrates an embodiment of a procedure 400 for identifying an incoming caller and playing back a previously recorded personalized outgoing message through a second line. In the embodiment illustrated in FIG. 4, the first communication device 110 supports establishment of communication sessions using at least two communication lines. In the embodiment illustrated in FIG. 4, the first communication device 110 is configured to support at least two communication lines, Line #1 and Line #2, to the network 135. Accordingly, the first communication device 110 may support a separate communication session on each of Line #1 and Line #2. In step 405, the procedure 400 begins. In step 410, Line #1 of the first communication device 110 is engaged with an established first incoming call and is in an off-hook mode and Line #2 is in an on-hook mode and idle. In step 415, a second incoming call from the second communication device 140 is received on Line #2 of the first communication device 110. In step 420, Line #2 enters the off-hook mode from the on-hook mode. In at least one embodiment, the DTAD 120 is configured to cause Line #2 of the first communication device 110 to enter the off-hook mode. In step 425, a caller identity of the second incoming call from the second communication device 140 is determined by the DTAD 120. In at least one embodiment, the caller identity of the second communication device 140 is determined from Caller ID information associated with the second communication device 140. In a particular embodiment, the Caller ID information includes Caller ID Type I information and/or Caller ID Type II information. Caller ID Type I provides calling party information while the call is ringing. Caller ID Type 2 additionally provides for calling number display while the recipient is on another call.

In step 430, the caller identity is matched with the entries of the pre-assigned caller list by the DTAD 120. In step 435, if the DTAD 120 matches the caller identity to an entry in the pre-assigned caller list, the procedure continues to step 440. In step 440, the second caller associated with the second incoming call from the second communication device 140 is prompted for a confirmation tone. In at least one embodiment, the confirmation tone is a DTMF tone generated by the second caller of the second communication device 140 pressing a key on a keypad associated with the second communication device 140.

In step 445, if it is determined that the second caller sent a confirmation tone within a predetermine time period, the procedure 400 continues to step 450. In at least one embodiment, the predetermined time period is determined to comply with rules specified by the Federal Communications Commission (FCC). In a particular embodiment, the predetermined time period is six seconds. In still another embodiment, the predetermined time period is four seconds. In step 450, the second caller's specific outgoing pre-recorded message associated with the caller identity is played back by the DTAD 120 to the caller of the second communication device 140 through Line #2 of the first communication device 110.

In step 455, the second caller is prompted regarding whether he wishes to leave an incoming message for the user of the first communication device 110 by entering a confirmation tone. In at least one embodiment, the confirmation tone is a DTMF tone generated by the second caller of the second communication device 140 pressing a key on a keypad associated with the second communication device 140. In one example embodiment, the second caller is prompted to press the “1” key if he wishes to leave an incoming message to the user of the first communication device 110. In step 460, if a confirmation tone is received within a predetermined time period, the procedure continues to step 475. In at least one embodiment, the predetermined time period is determined to comply with rules specified by the Federal Communications Commission (FCC). In a particular embodiment, the predetermined time period is six seconds. In still another embodiment, the predetermined time period is four seconds. In step 475, the second caller records an incoming message, and the incoming message is stored in the memory 130 of the DTAD 120 and the procedure continues to step 480. In step 480, Line #2 of the first communication device 110 returns to the on-hook mode. In the on-hook mode, the operating status of the communication line between the first communication device 110 and the network 135 is in a state in which data transmission is disabled. In at least one embodiment, the DTAD 120 is configured to cause Line #2 of the first communication device 110 to enter the off-hook mode. In step 485, the procedure 400 ends. If in step 445 the confirmation tone is not received within the predetermined time period the procedure continues to step 480. If in step 460 the confirmation tone is not received within the predetermined time period, the procedure 400 continues to step 480.

If in step 435 the DTAD 120 does not match the caller identity to an entry in the pre-assigned caller list, the procedure 400 continues to step 465 in which the DTAD 120 plays a standard outgoing message to the caller using Line #2. The standard outgoing message is not personalized towards a specific caller. In step 470, the DTAD 120 plays a beep or audible indication to the caller using Line #2 to indicate to the caller to record an incoming message and the procedure continues to step 475, 480, and 485.

The illustrative embodiments can take the form of an entirely hardware embodiment, an entirely software embodiment or an embodiment containing both hardware and software elements. Furthermore, the illustrative embodiments can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate or transport the program for use by or in connection with the instruction execution system, apparatus or device. In various embodiments, the customer premise equipment 105 includes one or more processors operable to execute computer executable instructions from a computer-usable or computer-readable medium to perform the various capabilities of the customer premise equipment 105 described herein.

The computer-usable or computer-readable medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), and DVD.

Further, a computer storage medium may contain or store a computer-readable program code such that when the computer-readable program code is executed on a computer, the execution of this computer-readable program code causes the computer to transmit another computer-readable program code over a communication link. This communication link may use a medium that is, for example without limitation, physical or wireless.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed as new and desired to be protected by letters patent of the United States is:

1. A method for providing a personalized greeting to a caller comprising:
receiving an incoming call by a first communication device from caller using a second communication device, the first communication device located at a customer premise location;
entering an off-hook mode by the first communication device;
determining a caller identity associated with the second communication device;
determining if the caller identity matches a pre-assigned caller identifier from a pre-assigned caller list; and
playing an outgoing message associated with the pre-assigned caller identifier if the caller identity matches the pre-assigned caller identifier from the pre-assigned caller list.

2. The method of claim 1, further comprising:
playing a standard outgoing message if the caller identifier does not match a pre-assigned caller identity from the pre-assigned caller list.

3. The method of claim 1, further comprising:
prompting the caller to send a confirmation tone if the caller wishes to leave an incoming message; and
recording an incoming message from the caller if the confirmation tone is received within a predetermined time period.

4. The method of claim 3, further comprising:
entering an on-hook mode by the first communication device if the confirmation tone is not received within the predetermined time period.

5. The method of claim 3, further comprising:
entering an on-hook mode by the first communication device subsequent to the recording of the incoming message from the caller.

6. The method of claim 1, further comprising:
prompting a user of the first communication device to record an outgoing message;
recording the outgoing message from the user; and
storing the outgoing message in a memory.

7. The method of claim 6, further comprising:
associating the pre-assigned caller identifier with the outgoing message; and
adding the pre-assigned caller identifier and associated outgoing message to the pre-assigned caller list.

8. The method of claim 6, further comprising:
entering an on-hook mode by the first communication device prior to the prompting of the user to record the outgoing message.

9. The method of claim 1, wherein the caller identity associated with the second communication device includes Caller ID information associated with the second communication device.

10. The method of claim 1, wherein the pre-assigned caller identifier includes a phone number associated with the second communication device.

11. The method of claim 1, wherein the pre-assigned caller identifier includes a caller name associated with the second communication device.

12. An apparatus for providing a personalized greeting to a caller comprising:
at least one processor, the at least one processor configured to:
receive an incoming call by a first communication device from caller using a second communication device, the first communication device located at a customer premise location;
enter an off-hook mode by the first communication device;
determine a caller identity associated with the second communication device;
determine if the caller identity matches a pre-assigned caller identifier from a pre-assigned caller list; and
play an outgoing message associated with the pre-assigned caller identifier if the caller identity matches the pre-assigned caller identifier from the pre-assigned caller list.

13. The apparatus of claim 11, wherein the at last one processor is further configured to:
play a standard outgoing message if the caller identifier does not match a pre-assigned caller identity from the pre-assigned caller list.

14. The apparatus of claim 11, wherein the at least one processor is further configured to:
prompt the caller to send a confirmation tone if the caller wishes to leave an incoming message; and
record an incoming message from the caller if the confirmation tone is received within a pre-determined time period.

15. The apparatus of claim 14, wherein the at least one processor is further configured to cause the first communication device to enter an on-hook mode if the confirmation tone is not received within the predetermined time period.

16. The apparatus of claim 14, wherein the at least one processor is further configured to cause the first communication device to enter an on-hook mode subsequent to the recording of the incoming message from the caller.

17. The apparatus of claim 11, wherein the at least one processor is further configured to:
prompt a user of the first communication device to record an outgoing message;
record the outgoing message from the user; and
store the outgoing message in a memory.

18. The apparatus of claim 17, wherein the at least one processor is further configured to:
associate the pre-assigned caller identifier with the outgoing message; and
add the pre-assigned caller identifier and associated outgoing message to the pre-assigned caller list.

19. The apparatus of claim 17, wherein the at least one processor is further configured to cause the first communication device to enter an on-hook mode prior to the prompting of the user to record the outgoing message.

20. The apparatus of claim 11, wherein the caller identity associated with the second communication device includes Caller ID information associated with the second communication device.
